(19) United States
(12) Patent Application Publication
(10) Pub. No.: US 2026/0260633 A1
(43) Pub. Date: Sep. 3, 2026

(54) FRET WIRE FOR STRINGED INSTRUMENT

(71) Applicant: Mark Eskander, Chadds Ford, PA (US)

(72) Inventor: Mark Eskander, Chadds Ford, PA (US)

(21) Appl. No.: 19/418,106

(22) Filed: Dec. 12, 2025

Related U.S. Application Data
(60) Provisional application No. 63/764,620, filed on Feb. 28, 2025.

(51) Int. Cl. G10D 1/08

(52) U.S. Cl. CPC G10D 1/08

(57) ABSTRACT

Exemplary embodiments are directed to fret wire for a stringed instrument including a fretboard with a slot formed in a top surface of the fretboard. The fret wire includes a bead including a bottom surface and a top edge. The bead defines a bead height measured from the bottom surface to the top edge of the bead. The fret wire includes a tang extending from the bottom surface of the bead and including a bottom surface. The tang defines a tang height measured from the bottom surface of the bead to the bottom surface of the tang. The bead and the tang extend along a fret wire length from a first end to a second end. The bead height varies from the first end to the second end along the fret wire length.

### CROSS-REFERENCE TO RELATED APPLICATIONS

This application claims the benefit of a co-pending, commonly assigned U.S. Provisional Patent Application No. 63/764,620, which was filed on Feb. 28, 2025. The entire content of the foregoing provisional application is incorporated herein by reference.

### TECHNICAL FIELD

The present disclosure relates to a fret wire for a stringed instrument and, in particular, to a fret wire that has a different radius relative to a fretboard radius when the fret wire is installed on the fretboard.

### BACKGROUND

Stringed instruments, such as guitars and basses, often include a neck with a fretboard having a predefined, fixed radius of curvature. Depending on the manufacturer, the radius for the top surface of the fretboard can range from about, e.g., 7.25-12 inches, inclusive. FIGS. 1 and 2 provide examples of different fretboards mounted to a neck. In particular, FIG. 1 shows a fretboard 10 mounted to a neck 12, with a top surface 14 of the fretboard 10 having a curvature with a radius 16 of about 7.25 inches. FIG. 2 shows a fretboard 20 mounted to a neck 22, with a top surface 24 of the fretboard 20 having a curvature with a radius 26 of about 9.5 inches.

The radius of the fretboard typically remains constant along the entire length of the neck, and is selected to achieve comfort for the player and overall playability of the instrument. However, some players may prefer the comfort of a more curved fretboard (e.g., a radius of 7.25 inches) near the nut for chord work, but may prefer a flatter, more precise fretboard curvature (e.g., a radius of 9.5 inches) near the bridge for easier soloing and lead playing. Some manufacturers achieve this variation in curvature with a compound radius fretboard, which gradually transition the curvature of the fretboard 14, 24 along its length. However, manufacturing the compound radius fretboard can be complex and expensive, as compared to a fixed radius fretboard.

A typical fretboard 30 for a stringed instrument is illustrated in FIG. 3. The fretboard 30 includes a top, player-facing surface 32 which can have a curvature defining the radius of the fretboard 30. During manufacturing, lateral slots 34, 36, 38 are formed in the top surface 32 in a spaced manner for installation of fret wire into the slots 34-38. The spacing between the slots 34-38 is selected by the manufacturer based on the scale of the neck and the optimal intonation of the instrument. In general, the depth of the slots 34-38 can be substantially uniform across the width of the fretboard 30.

FIG. 4 is a diagrammatic, partial view of a fret wire 40 used in the industry. The fret wire 40 generally includes a bead 42 and a tang 44 extending from a bottom surface of the bead 42. The bead 42 can define a substantially dome-shaped configuration with a curved top surface 46. The bead 42 can define a width 48 and a height 50 that extends uniformly along the entire length 52 of the fret wire 40. The tang 44 defines a height 54 extending perpendicularly from the bottom surface of the bead 42, and a width 56 dimensioned smaller than the width 48 of the bead 42 and configured to be press fit into the slots 34-38 of the fretboard 30 of FIG. 3. In some instances, the side surfaces of the tang 44 can include protrusions 58 that assist with the press fit engagement between the tang 44 and the walls of the slots 34-38. The fret wire 40 defines a height 60 that is uniform along the entire length 52 of the fret wire 40.

During installation, the tang 44 is aligned over the respective slot 34-38 and a hammer can be used to drive the tang 44 into the slot 34-38 until the bottom surface of the bead 42 abuts the top surface 32 of the fretboard 30. Due to the uniform height 50 of the bead 42, the radius formed by the top surface 46 (e.g., uppermost edge) of the bead 42 follows the radius of the top surface 32 of the fretboard 30. Conventional fret wire 40 therefore maintains the same radius of curvature as the fretboard 30.

Thus, a need exists for a fret wire that varies the radius of curvature along the top edge of the fret wire relative to the fretboard radius without modifying the radius of the fretboard or neck. These and other needs are addressed by the fret wire of the present disclosure.

### SUMMARY

In accordance with embodiments of the present disclosure, an exemplary fret wire for a stringed instrument is provided. The stringed instrument includes a fretboard with a slot formed in a top surface of the fretboard. The fret wire includes a bead including a bottom surface and a top edge. The bead defines a bead height measured from the bottom surface to the top edge of the bead. The fret wire includes a tang extending from the bottom surface of the bead and including a bottom surface. The tang defines a tang height measured from the bottom surface of the bead to the bottom surface of the tang. The bead and the tang extend along a fret wire length from a first end to a second end. The bead height varies from the first end to the second end along the fret wire length.

The bottom surface of the bead is configured to abut the top surface of the fretboard after installation of the fret wire in the slot of the fretboard. The tang is configured to be at least partially inserted into the slot of the fretboard during installation of the fret wire in the slot of the fretboard. The tang height can be constant from the first end to the second end along the fret wire length.

The bead height can include or defines a first bead height at the first and second ends, and a second bead height at a central section located between the first and second ends. In some embodiments, the first bead height can be dimensioned greater than the second bead height. In some embodiments, the top edge of the bead can define a concave curvature. In some embodiments, the second bead height can be dimensioned greater than the first bead height. In some embodiments, the top edge of the bead can define a convex curvature.

The bead height can gradually transition from the first bead height at the first and second ends to the second bead height at the central section. In some embodiments, the bead height can vary from the first end to the second end along the fret wire length in a symmetrical manner. In some embodiments, the bead height can vary from the first end to the second end along the fret wire length in an asymmetric manner. The bead can define a substantially constant width extending along the fret wire length from the first end to the second end. The top edge of the bead can define a semi-circular cross-section. When installed in the slot of the fretboard, a radius of the top edge of the bead is different from a radius of the top surface of the fretboard.

In accordance with embodiments of the present disclosure, an exemplary fret wire system is provided. The system includes a stringed instrument including a fretboard with a slot formed in a top surface of the fretboard. The system includes a fret wire. The fret wire includes a bead including a bottom surface and a top edge. The bead defines a bead height measured from the bottom surface to the top edge of the bead. The fret wire includes a tang extending from the bottom surface of the bead and including a bottom surface. The tang defines a tang height measured from the bottom surface of the bead to the bottom surface of the tang. The bead and the tang extend along a fret wire length from a first end to a second end. The bead height varies from the first end to the second end along the fret wire length.

The tang is configured to be at least partially inserted into the slot of the fretboard during installation of the fret wire in the slot of the fretboard. The top surface of the fretboard defines a radius (e.g., zero or non-zero) and, when the tang is at least partially inserted into the slot of the fretboard, a radius of the top edge of the bead is different from the radius of the top surface of the fretboard. In some embodiments, the top edge of the bead can define a concave curvature. In some embodiments, the top edge of the bead can define a convex curvature.

In accordance with embodiments of the present disclosure, an exemplary method of fret wire installation for a stringed instrument including a fretboard with a slot formed in a top surface of the fretboard is provided. The method includes at least partially inserting a tang of a fret wire into the slot formed in the top surface of the fretboard of the stringed instrument. The fret wire includes a bead including a bottom surface and a top edge. The bead defines a bead height measured from the bottom surface to the top edge of the bead. The fret wire includes the tang extending from the bottom surface of the bead and including a bottom surface. The tang defines a tang height measured from the bottom surface of the bead to the bottom surface of the tang. The bead and the tang extend along a fret wire length from a first end to a second end. The bead height varies from the first end to the second end along the fret wire length. When the tang is at least partially inserted into the slot of the fretboard, a radius of the top edge of the bead is different from a radius of the top surface of the fretboard.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed fret wire for a stringed instrument, reference is made to the accompanying figures, wherein:

FIG. 1 is a diagrammatic, cross-sectional view of a fretboard of a stringed instrument having a radius of about 7.25 inch;

FIG. 2 is a diagrammatic, cross-sectional view of a fretboard of a stringed instrument having a radius of about 9.5 inches;

FIG. 3 is a detailed, perspective view of a fretboard of a stringed instrument;

FIG. 4 is a diagrammatic, perspective view of a conventional fret wire;

FIG. 5 is a diagrammatic, front view of an exemplary fret wire for a stringed instrument configured to have a radius greater than a radius of a fretboard after installation;

FIG. 6 is a diagrammatic, side view of an exemplary fret wire of FIG. 5;

FIG. 7 is a diagrammatic, cross-sectional view of an exemplary fret wire of FIG. 5 installed on a fretboard and having a radius greater than a radius of the fretboard;

FIG. 8 is a diagrammatic, front view of an exemplary fret wire for a stringed instrument configured to have a radius smaller than a radius of a fretboard after installation;

FIG. 9 is a diagrammatic, side view of an exemplary fret wire of FIG. 8; and

FIG. 10 is a diagrammatic, cross-sectional view of an exemplary fret wire of FIG. 8 installed on a fretboard and having a radius smaller than a radius of the fretboard.

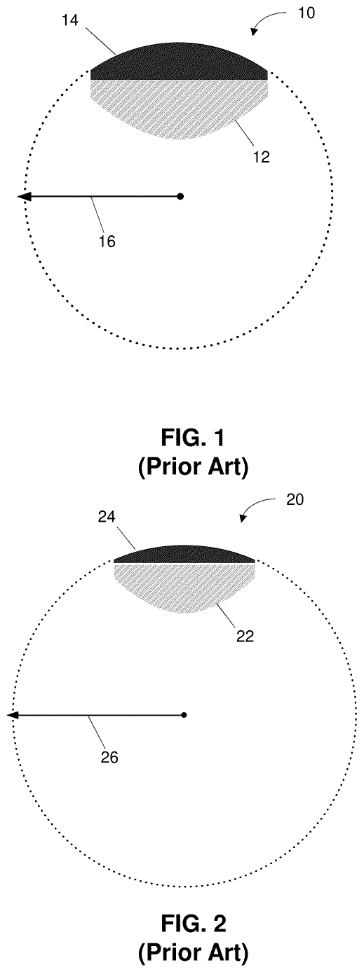

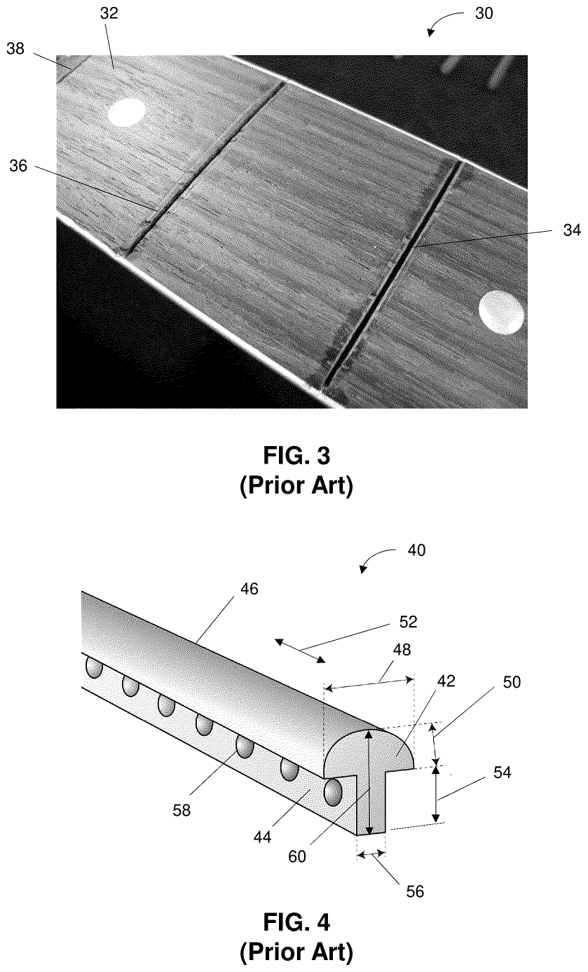

### DETAILED DESCRIPTION

The exemplary fret wire discussed herein provides a solution for achieving a resulting radius along the top or uppermost edge of the fret wire that is different from the radius of the fretboard on which the fret wire is installed. In particular, after installation into a slot in the fretboard, the top or uppermost edge of the fret wire has a different radius that the radius of the fretboard immediately adjacent to the slot on both sides of the slot. As an example, the fret wire can be installed on a fretboard with a fixed radius (e.g., 7.25 inches) while providing an effective radius of 9.5 inches along the top edge of the fret wire after installation. As a further example, the fret wire can be installed on a fretboard with a fixed radius (e.g., 9.5 inches) while providing an effective radius of 7.25 inches along the top edge of the fret wire after installation.

The fret wire can be installed on fretboards having a uniform radius or a compound radius. In some embodiments, the same fret wire can be used along the entire length of the fretboard. In some embodiments, different fret wire can be used along the length of the fretboard to gradually change the radius along the top edge of the fret wire. For example, a group of frets installed near the nut can be of a smaller radius, while another group of frets further down the neck can be of a larger radius. The resulting fret wire configuration allows for improved playability with a customized feel depending on the player (e.g., a higher radius for a flatter feel ideal for lead playing), while maintaining the comfort of the lower radius for chord work.

The exemplary fret wire provides a simpler and cost-effective solution to modifying the radius of the surfaces in contact with the strings of the instrument by modifying only the fret wire itself, rather than modifying the fretboard and/or neck. Use of the exemplary fret wire provides improved ergonomics and playability without requiring modifications to the fretboard and/or neck. An efficient radius transition across the entire fretboard can therefore be achieved without changing the underlying curvature of the fretboard.

In some embodiments, the fret wire can be installed on a 7.25 inch radius fretboard, which is typical for traditional stringed instruments. In some embodiments, the top surface of each fret wire can be shaped to create a radius that corresponds to a larger radius, e.g., 9.5 inches, or the like. However, it should be understood that any radius adjustment can be made with the fret wire, so long as the resulting radius along the top surface of the installed fret wire is different from the radius of the fretboard. In some embodiments, if different radii of fret wire are installed along the fretboard, one or more frets can include the same radius as the fretboard while surrounding frets have a radius different from the fretboard radius. The top surface of the fret wire is not uniform in height, and is instead shaped to ensure that the effective radius of the playing surface matches the desired larger (or smaller) radius. The base or tang of the fret wire remains constant along the length of the fret wire.

During installation, the base of the fret wire can match the curvature of the fretboard, while the top surface of the fret wire defines a curvature different from the fretboard radius. In particular, the top portion of the fret wire (e.g., the surface the strings touch when playing the instrument) is engineered to have a curvature (concave or convex) to mimic a smaller or larger radius after installation. The curvature of the top surface of the fret wire prior to installation allows for modification of the playing surface radius without modifying the actual fretboard.

In some embodiments, the fret wire can be manufactured with a pre-shaped top surface that matches the desired radius. In some embodiments, the fret wire can be manufactured with standard fret wire profiles, and the top surface can be subsequently modified during installation or fret dressing to achieve the desired radius along the top surface. In some embodiments, the material of the fret wire can include one or more of the following non-limiting examples: nickel, silver, stainless steel, any durable alloys known for their wear resistance, or the like.

In some embodiments, the radius of the top surface of the frets can be applied equally across the entire fretboard, providing the same effective radius for both the bass and treble sides or strings. The flatter radius near the bridge (achieved by the larger radius on the fret wires) improves the comfort and playability for fast lead playing, while the underlying smaller radius still provides a curved feel near the nut for easier chord work. The transition from the nut to the bridge creates an effective compound radius feel without manufacturing a compound radius fretboard or multiple types of fret wire.

The exemplary fret wire can provide advantages in terms of cost effectiveness, improved playability, uniformity, and enhanced ergonomics. Use of the fret wires can eliminate the need for a compound radius fretboard, reducing overall manufacturing costs and complexity. The player can experience the best of both worlds with the comfort of a smaller radius near the nut for chord work and the precision of a larger radius near the bridge for lead playing. The entire fretboard can maintain the same underlying radius, with the frets providing the desired effective radius. The fret wires allow for smoother and faster lead playing, as the flatter large radius improves the player's ability to navigate the higher frets with ease.

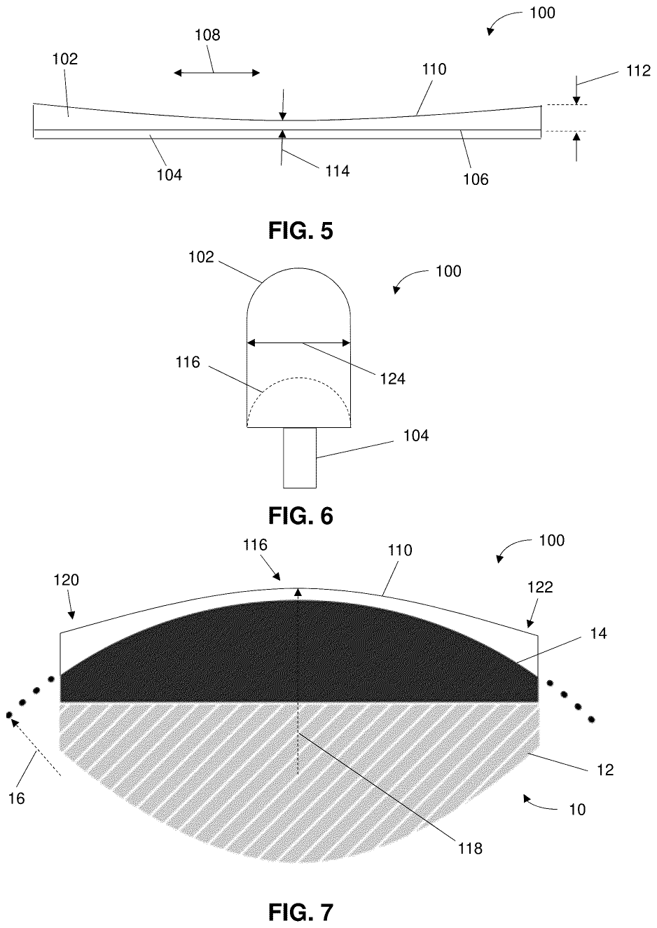

FIGS. 5 and 6 are a diagrammatic, front and views of an exemplary fret wire 100 for a stringed instrument. After installation on the fretboard of the stringed instrument, the fret wire 100 is configured to have a greater radius along its top surface than the radius of the top surface of the fretboard. In particular, after installation, the radius along the top surface of the fret wire 100 is greater than the radius at the fretboard immediately adjacent to the slot into which the fret wire 100 is installed.

The fret wire 100 includes a body with a bead 102 and a tang 104 extending from a bottom surface 106 of the bead 102. The tang 104 can define a substantially rectangular cross-section extending perpendicularly from the bottom surface 106 of the bead 102 (see, e.g., FIG. 6). The cross-section (specifically the height) of the tang 104 remains constant along the entire length 108 of the fret wire 100. In some embodiments, the length 108 can be dimensioned slightly longer than the fretboard radial width such that the fret wire 100 can be installed into the slot formed in the fretboard and the ends of the fret wire can be clipped or otherwise cut to be aligned with ends of the fretboard. In some embodiments, the length 108 can be dimensioned substantially equal to the slot length in the fretboard configured to receive the tang 104.

In contrast, the cross-section of the bead 102 changes across the length 108 of the fret wire 100. The uppermost or top edge 110 of the bead 102 defines an inwardly curved (e.g., concave) configuration, such that opposing ends of the bead 102 have a height 112 dimensioned greater than a height 114 of a center point or central section 116 of the bead 102. The top edge 110 therefore does not extend parallel to the tang 104 along the length 108 of the fret wire 100. The opposing ends of the bead 102 define an equal height 112, and the curvature gradually transitions to the central section 116. As a non-limiting example, the height 112 can be about, e.g., 0.9 inches, or the like, and the height 114 can be about, e.g., 0.45 inches, or the like. However, it should be understood that any heights can be used to allow for a range of different effective curvatures to be achieved after installation of the fret wire 100 on a fretboard, as long as the height 112 on the opposing ends is greater than the height 114 at the central section 116. As illustrated in FIG. 6, the overall width 124 of the bead 102 remains constant along the entire length 108 of the fret wire 100. The top surface 110 defines a substantially semi-circular, symmetric configuration along the length 108. It should be understood that the height 112, 114 differences are exaggerated for purposes of illustration only.

In some embodiments, the height of the bead 102 can be asymmetric along the length 108. In some embodiments, the height of the bead 102 at the opposing ends can be greater than the height 114, but not necessarily equal to each other. For example, if a smaller radius is desired at the low E string and a higher radius is desired at the high E string, the height at the left end of the bead 102 (to be installed at the low E string location) would be dimensioned less than the height at the right end of the bead 102 (to be installed at the high E string location), with both heights at the opposing ends still greater than the height 114 at the central section 116. In some embodiments, only one of the opposing ends of the bead 102 can have a height 112 greater than the height 114 at the central section 116. For example, the right end of the bead 102 (to be installed on the high E string location) can have a height 112 greater than the height 114 at the central section 116, and the left end of the bead 102 (to be installed on the low E string location) can have a height dimensioned equal to or less than the height 114 of the central section 116. As a result, the bead 102 height can be asymmetric across the length 108 of the bead 102. The bead 102 can thereby vary the resulting radius at the neck of the stringed instrument across the width of the fretboard in an asymmetric manner.

FIG. 7 is a diagrammatic, cross-sectional view of the exemplary fret wire 100 installed on a fretboard 10 having a top surface 14 with a radius 16 (e.g., a fret wire system). During installation, the bottom surface of the uniform height of the tang 104 is aligned with and hammered into a slot formed in the fretboard 10. After full insertion of the tang 104 into the slot, the bottom surface 106 of the bead 102 is positioned against the top surface 14 of the fretboard 10 on opposing sides of the slot. Conventional fret wires include a bead with a uniform height (see, e.g., FIG. 4), and the result of installation of such conventional fret wires is that the top surface of the bead defines the same radius as the radius 16 of the fretboard 10.

In contrast, due to the varying height 112, 114 of the bead 102 of the exemplary fret wire 100, the resulting radius 118 along the top surface 110 of the bead 102 is different from the radius 16 of the fretboard 10 immediately adjacent to the slot in which the fret wire 100 has been installed. In particular, due to the smaller height 114 at the central section 116, the top surface 110 of the bead 102 is positioned closer to the top surface 14 of the fretboard 10 (relative to the ends 120, 122). Due to the greater height 112 at the opposing ends 120, 122 of the bead 102, the top surface 110 of the bead 102 is positioned further from the top surface 14 of the fretboard 10. As a result, the radius 118 along the top surface 110 of the fretboard 10 is greater than the radius 16 of the fretboard 10. This change in the radius of the surface 110 to be in contact with strings of the instrument is achieved without modifying the fretboard 10 or neck 12, and provides improved playability for lead playing, for example.

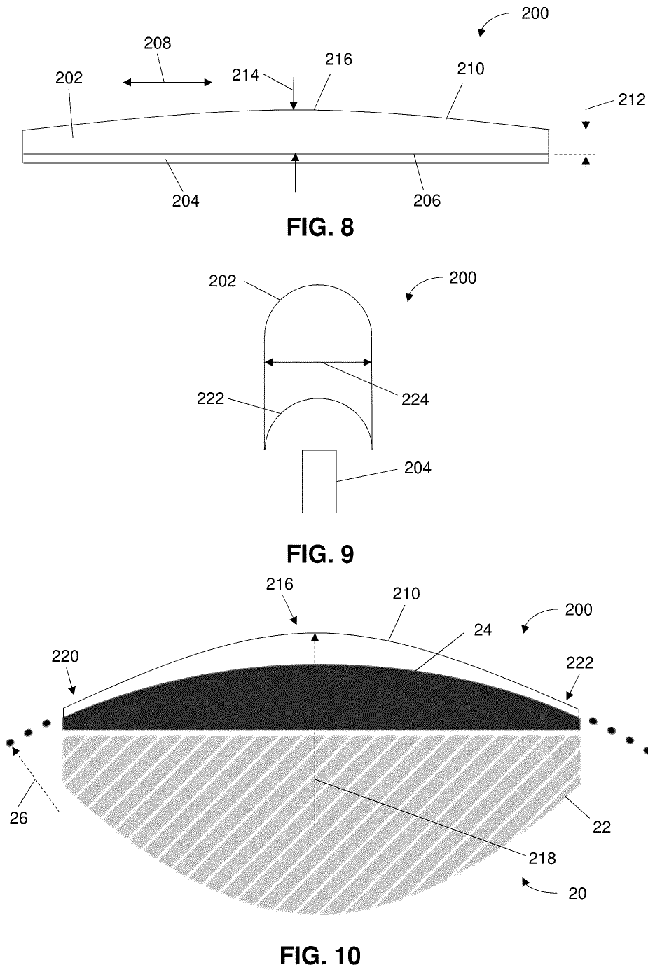

FIGS. 8 and 9 are a diagrammatic, front and views of an exemplary fret wire 200 for a stringed instrument. After installation on the fretboard of the stringed instrument, the fret wire 200 is configured to have a smaller radius along its top surface than the radius of the top surface of the fretboard. In particular, after installation, the radius along the top surface of the fret wire 200 is smaller than the radius at the fretboard immediately adjacent to the slot into which the fret wire 200 is installed.

The fret wire 200 includes a body with a bead 202 and a tang 204 extending from a bottom surface 206 of the bead 202. The tang 204 can define a substantially rectangular cross-section extending perpendicularly from the bottom surface 206 of the bead 202 (see, e.g., FIG. 9). The cross-section (specifically the height) of the tang 204 remains constant along the entire length 208 of the fret wire 200. In some embodiments, the length 208 can be dimensioned slightly longer than the fretboard radial width such that the fret wire 200 can be installed into the slot formed in the fretboard and the ends of the fret wire can be clipped or otherwise cut to be aligned with ends of the fretboard. In some embodiments, the length 208 can be dimensioned substantially equal to the slot length in the fretboard configured to receive the tang 204.

In contrast, the cross-section of the bead 202 changes across the length 208 of the fret wire 200. The uppermost or top edge 210 of the bead 202 defines an outwardly curved (e.g., convex) configuration, such that opposing ends of the bead 202 have a height 212 dimensioned smaller than a height 214 of a center point or central section 216 of the bead 202. The top edge 210 therefore does not extend parallel to the tang 204 along the length 208 of the fret wire 200. The opposing ends 220, 222 of the bead 202 define an equal height 212, and the curvature gradually transitions to the central section 216 (see, e.g., FIGS. 8-10). As a non-limiting example, the height 212 can be about, e.g., 0.45 inches, or the like, and the height 214 can be about, e.g., 0.6 inches, or the like. However, it should be understood that any heights can be used to allow for a range of different effective curvatures to be achieved after installation of the fret wire 200 on a fretboard, as long as the height 214 in the central section 216 is greater than the height 212 at the opposing ends. As illustrated in FIG. 9, the overall width 224 of the bead 202 remains constant along the entire length 208 of the fret wire 200. The top surface 210 defines a substantially semi-circular, symmetric configuration along the length 208. It should be understood that the height 212, 214 differences are exaggerated for purposes of illustration only.

In some embodiments, the height of the bead 202 can be asymmetric along the length 208. In some embodiments, the height of the bead 202 at the opposing ends can be less than the height 214, but not necessarily equal to each other. For example, if a smaller radius is desired at the low E string and a higher radius is desired at the high E string, the height at the left end of the bead 202 (to be installed at the low E string location) would be dimensioned less than the height at the right end of the bead 202 (to be installed at the high E string location), with both heights at the opposing ends still greater than the height 214 at the central section 216. In some embodiments, only one of the opposing ends of the bead 202 can have a height 212 smaller than the height 214 at the central section 216. For example, the left end of the bead 202 (to be installed on the low E string location) can have a height 212 smaller than the height 214 at the central section 216, and the right end of the bead 202 (to be installed on the high E string location) can have a height dimensioned equal to or greater than the height 214 of the central section 216. As a result, the bead 202 height can be asymmetric across the length 208 of the bead 202. The bead 202 can thereby vary the resulting radius at the neck of the stringed instrument across the width of the fretboard in an asymmetric manner.

FIG. 10 is a diagrammatic, cross-sectional view of the exemplary fret wire 200 installed on a fretboard 20 having a top surface 24 with a radius 16 (e.g., a fret wire system). During installation, the bottom surface of the uniform height of the tang 204 is aligned with and hammered into a slot formed in the fretboard 20. After full insertion of the tang 204 into the slot, the bottom surface 206 of the bead 202 is positioned against the top surface 24 of the fretboard 20 on opposing sides of the slot. Conventional fret wires include a bead with a uniform height (see, e.g., FIG. 4), and the result of installation of such conventional fret wires is that the top surface of the bead defines the same radius as the radius 26 of the fretboard 20.

In contrast, due to the varying height 212, 214 of the bead 202 of the exemplary fret wire 200, the resulting radius 218 along the top surface 210 of the bead 202 is different from the radius 26 of the fretboard 20 immediately adjacent to the slot in which the fret wire 200 has been installed. In particular, due to the greater height 214 at the central section 216, the top surface 210 of the bead 102 is positioned further from the top surface 24 of the fretboard 20 (relative to the ends 220, 222). Due to the smaller height 212 at the opposing ends 220, 222 of the bead 202, the top surface 210 of the bead 202 is positioned further from the top surface 24 of the fretboard 20. As a result, the radius 218 along the top surface 210 of the fretboard 20 is smaller than the radius 26 of the fretboard 20. This change in the radius of the surface 210 to be in contact with strings of the instrument is achieved without modifying the fretboard 20 or neck 22, and provides improved playability for chord work, for example.

The exemplary fret wires 100, 200 discussed herein therefore provide options for customization of the stringed instrument based on preferences by the player. The radius along the top surface of the fret wire 100, 200 can be selected specifically based on the needs of the player, and ensures that the surface contacting the strings of the instrument will be optimally configured for the player. Various height differences and curvatures of the bead of the fret wires 100, 200 can be used to ensure the desired effective playing radius is achieved after installation of the fret wires 100, 200.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A fret wire for a stringed instrument including a fretboard with a slot formed in a top surface of the fretboard, the fret wire comprising:
a bead including a bottom surface and a top edge, the bead defining a bead height measured from the bottom surface to the top edge of the bead; and
a tang extending from the bottom surface of the bead and including a bottom surface, the tang defining a tang height measured from the bottom surface of the bead to the bottom surface of the tang;
wherein the bead and the tang extend along a fret wire length from a first end to a second end; and
wherein the bead height varies from the first end to the second end along the fret wire length.

2. The fret wire of claim 1, wherein the bottom surface of the bead is configured to abut the top surface of the fretboard after installation of the fret wire in the slot of the fretboard.

3. The fret wire of claim 1, wherein the tang is configured to be at least partially inserted into the slot of the fretboard during installation of the fret wire in the slot of the fretboard.

4. The fret wire of claim 1, wherein the tang height is constant from the first end to the second end along the fret wire length.

5. The fret wire of claim 1, wherein the bead height includes a first bead height at the first and second ends, and a second bead height at a central section located between the first and second ends.

6. The fret wire of claim 5, wherein the first bead height is greater than the second bead height.

7. The fret wire of claim 1, wherein the top edge of the bead defines a concave curvature.

8. The fret wire of claim 5, wherein the second bead height is greater than the first bead height.

9. The fret wire of claim 1, wherein the top edge of the bead defines a convex curvature.

10. The fret wire of claim 5, wherein the bead height gradually transitions from the first bead height at the first and second ends to the second bead height at the central section.

11. The fret wire of claim 1, wherein the bead height varies from the first end to the second end along the fret wire length in an asymmetric manner.

12. The fret wire of claim 1, wherein the top edge of the bead defines a semi-circular cross-section.

13. The fret wire of claim 1, wherein when installed in the slot of the fretboard, a radius of the top edge of the bead is different from a radius of the top surface of the fretboard.

14. A fret wire system, comprising:
a stringed instrument including a fretboard with a slot formed in a top surface of the fretboard; and
a fret wire, the fret wire comprising:
a bead including a bottom surface and a top edge, the bead defining a bead height measured from the bottom surface to the top edge of the bead; and
a tang extending from the bottom surface of the bead and including a bottom surface, the tang defining a tang height measured from the bottom surface of the bead to the bottom surface of the tang;
wherein the bead and the tang extend along a fret wire length from a first end to a second end; and
wherein the bead height varies from the first end to the second end along the fret wire length.

15. The fret wire system of claim 14, wherein the tang is configured to be at least partially inserted into the slot of the fretboard during installation of the fret wire in the slot of the fretboard.

16. The fret wire system of claim 15, wherein the top surface of the fretboard defines a radius and, when the tang is at least partially inserted into the slot of the fretboard, a radius of the top edge of the bead is different from the radius of the top surface of the fretboard.

17. The fret wire system of claim 14, wherein the top edge of the bead defines a concave curvature.

18. The fret wire system of claim 14, wherein the top edge of the bead defines a convex curvature.

19. A method of fret wire installation for a stringed instrument including a fretboard with a slot formed in a top surface of the fretboard, the method comprising:
at least partially inserting a tang of a fret wire into the slot formed in the top surface of the fretboard of the stringed instrument, wherein the fret wire includes (i) a bead including a bottom surface and a top edge, the bead defining a bead height measured from the bottom surface to the top edge of the bead, (ii) the tang extending from the bottom surface of the bead and including a bottom surface, the tang defining a tang height measured from the bottom surface of the bead to the bottom surface of the tang;
wherein the bead and the tang extend along a fret wire length from a first end to a second end; and
wherein the bead height varies from the first end to the second end along the fret wire length.

20. The method of claim 19, wherein when the tang is at least partially inserted into the slot of the fretboard, a radius of the top edge of the bead is different from a radius of the top surface of the fretboard.
